(19) United States
(12) Patent Application Publication
(10) Pub. No.: US 2022/0363930 A1
(43) Pub. Date: Nov. 17, 2022

(54) Method for the Production of at Least One Carrier Material Provided With a Print Decoration

(71) Applicant: Flooring Technologies Ltd., Kalkara (MT)

(72) Inventor: Frank Oldorff, Schwerin (DE)

(21) Appl. No.: 17/621,516

(22) PCT Filed: Jun. 12, 2020
(86) PCT No.: PCT/EP2020/066390

§ 371 Date: Dec. 21, 2021

(30) Foreign Application Priority Data
Jun. 25, 2019 (EP) 19182230.3

(51) Int. Cl. C09D 11/40; C09D 11/324

(52) U.S. Cl. CPC C09D 11/40; C09D 11/324

(57) ABSTRACT

Provided is a method for the production of at least one carrier material provided with a print decoration. The print decoration is applied to the at least one carrier material by means of digital printing. The ink used for digital printing is a water-soluble CRYK ink containing at least one cyan pigment, at least one red pigment from the group of quinacridone pigments, the yellow pigment PY181, and at least one black carbon pigment.

### CROSS-REFERENCE TO RELATED APPLICATIONS

This application is the United States national phase of International Application No. PCT/EP2020/066390 filed Jun. 12, 2020, and claims priority to European Patent Application No. 19182230.3 filed Jun. 25, 2019, the disclosures of which are hereby incorporated by reference in their entirety.

### BACKGROUND OF THE INVENTION

### Field of the Invention

The present invention relates to a method of producing a carrier material provided with a printed decoration, in particular a printed paper or a printed material board.

### Description of Related Art

Decorated carrier materials, such as wood-based panels, are typically used as flooring elements or for cladding walls and ceilings. In the past, the wood-based panels used as substrates were usually coated with a decorative paper, whereby there were and are no limits to the variety of different patterned decorative papers.

As an alternative to the use of decorative papers on wood-based panels, direct printing on wood-based panels as substrates has developed in the past, since printing on paper and its subsequent lamination or direct coating on the wood-based panel is no longer necessary.

The main printing techniques used are gravure printing and digital printing. Gravure printing is a printing technique in which the elements to be reproduced are present as depressions in a printing form that is inked before printing. The ink is primarily located in the depressions and is transferred to the object to be printed, such as a carrier material, due to contact pressure of the printing form and adhesion forces. In digital printing, on the other hand, the printed image is transferred directly from a computer to a printing machine such as a laser printer or inkjet printer. This eliminates the use of a static printing form.

However, in the context of the technical development of the printing technology of various carrier materials, digital printing is being used more and more. While digital printing processes were initially used primarily in the graphic arts industry, e.g. advertising agencies, advertising material manufacturers or printers, it is now becoming apparent that digital printing processes are also being used more frequently in other branches of industry. There are many reasons for this, but two main arguments can be identified. Digital printing enables the production of a print image with a particularly high quality due to a higher resolution and also allows a wider range of applications with a high degree of flexibility.

Today, digital printing is performed almost exclusively using the CMYK color system. The CMYK color model is a subtractive color model, where the abbreviation CMYK stands for the three color components cyan, magenta, yellow (yellow) and the black component key as color depth. With this color system, a color space (gamut) can be mapped that satisfies many requirements from a wide variety of areas.

Nevertheless, the CMYK color space is a compromise which leads to the fact that certain colors either cannot be generated at all or the use of additional colors is necessary. This problem arises particularly in the reproduction of wood decors in the furniture or laminate flooring industry, where different shades of brown must be produced.

### SUMMARY OF THE INVENTION

The technical object underlying the proposed solution was therefore to provide a method for producing decorative prints on different carrier materials with the same quality or comparable quality appearance while avoiding metamerism, while ensuring good reproduction of warm-looking wood decors on all carrier materials.

This object is solved by a method having features as described herein.

Accordingly, a method for producing at least one carrier material provided with a print decoration is provided, wherein the print decoration is applied to the at least one carrier material by means of digital printing, for example in an inkjet printing process.

According to the solution, the ink used for digital printing is a water-soluble CRYK ink containing at least one cyan pigment, at least one red pigment of the group of quinacridone pigments, the yellow pigment PY181 and at least one black carbon pigment.

Accordingly, the present method uses an ink in which the magenta usually used in ink-jet inks is replaced by a red color pigment. With this ink, it is now possible to provide decorations on various carrier materials which are shifted in the color space in the direction of orange-red.

The present method makes it possible to provide decorative papers for furniture, floor panels and high pressure laminates and laminate panels with the same decor and colour effect, i.e. furniture, floor and edges in a matching decor and colour effect.

In particular, it is possible to avoid metamerism effects due to the use of the modified ink. Metamerism means that, due to the use of different color pigments, prints sometimes look the same in color and sometimes different in color under different types of light. This results from the different reflection or transmission curves of the pigments. The use of a CMYK ink set now avoids these effects for different substrates, in particular the same pigments can be used in gravure printing, so that both digital printing and gravure printing processes can be used while avoiding metamerism.

EP 2 865 529 B1 describe the use of a CRYK ink for printing on a paper substrate. In addition to a cyan pigment and a carbon black pigment, this CRYK ink contains the red pigment PR 254 and the yellow pigment PY151.

The red pigment PR254 belongs to the class of diketopyrrolopyrrole pigments and is described with a yellowish-red color. PR254 is preferably used in automotive coatings. The yellow pigment PY151 is a benzimidazolone pigment.

However, the disadvantage of using PR254 and PY151 in the provision of printing decors for various substrates for use in the furniture and laminate flooring industry is an insufficient color shift towards orange-red as well as the comparatively high cost of these pigments.

In contrast, the use of a red pigment from the group of quinacridone pigments according to the solution enables the desired color shift to be achieved at lower cost while avoiding metamerism.

As mentioned, the red pigment used in the present method is based on a quinacridone pigment. These belong to a group of organic pigments derived from the basic structure of quinacridone. They exhibit very good weather fastness, high color strength and high chemical resistance.

The used red pigment is preferably selected from the group of quinacridone pigments are 2,9-dimethylquinacridone (pigment red 122), 2,9-dichloroquinacridone (pigment red 202), mixed crystal of quinacridone and 4,11-dichloroquinacridone (pigment red 207) and 3,10-dichloroquinacridone (pigment red 209).

The red pigment PR207 as a mixed crystal of quinacridone and 4,11-dichloroquinacridone is preferably used. A mixed crystal is to be understood as a solid solution which differs from a purely physical mixture of the individual components. In a mixed crystal, for example, the molecules of one component are incorporated into the crystal lattice of the other component. PR207 is described with a yellowish-red color.

Like PY151, the yellow pigment PY181 used in the present method is a benzimidazolone azo pigment, but has different substituents. For example, PY181 contains an amidobenzene side chain as R4 substituent, while PY151 has only a hydrogen at the same position. PY181 exhibits good acid and base stability, solvent stability, and good dispersibility.

In one embodiment of the ink used in the present method, the at least one cyan pigment is a copper phthalocyanine pigment, preferably C.I. Pigment Blue 15:3 or C.I. Pigment Blue 15:4, more preferably C.I. Pigment Blue 15:3.

In another embodiment of the ink used in the present method, the black carbon pigment is a carbon black pigment, particularly selected from the group consisting of Regal™ 400R, Mogul™, L, Elftex™ 320 from Cabot Co, or Carbon Black FW18, Special Black™ 250, Special Black™ 350, Special Black™ 550, Printex™ 25, Printex™ 35, Printex™ 55, Printex™ 90, Printex™ 150T from DEGUSSA Co, MA8 from MITSUBISHI CHEMICAL Co, and C.I. Pigment Black 7 and C.I. Pigment Black 11.

The pigment concentration in the ink used herein, in particular with respect to the red and yellow pigment, is more than 2% by weight, preferably between 2.2 and 6% by weight, more preferably between 2.5 and 5% by weight, based on the total weight of the ink.

As mentioned above, the ink used herein is an aqueous ink. The water content in the ink is at least 50%, preferably above 50%, more preferably at least 55%, for example 51%, 52% or 53%.

The ink used herein also has a solvent content. Thus, the ink comprises at least one organic solvent in a proportion of less than 45%, preferably less than 43%; e.g. 41%, 42%.

The organic solvent keeps the ink in a processable consistency, especially in combination with further additives such as dispersing aids. Glycol or other alcohols, such as ethanol, can be used as organic solvent.

In addition, the ink used herein may have further additives such as biocides, humectants, acid/bases for pH adjustment, and surfactants as surface active agents. As humectants, among others, 2-pyrrolidone, glycerol and 1,2-hexanediol may be present in an amount between 0.1 and 25% by weight, based on the total weight of the aqueous ink-jet ink.

As mentioned above, the present method can be used to print on various carrier materials.

Thus, in one embodiment, the at least one carrier material to be printed is at least one base paper. In this context, base papers are understood to be papers that have not been subjected to sizing in the mass or impregnation of the surface with a resin or glue. Base papers consist essentially of pulps, pigments and fillers and usual additives. For the production of base papers such as decor papers, softwood pulps, hardwood pulps, or mixtures of both types of pulp can be used. Inorganic color pigments such as metal oxides, metal hydroxides and metal oxide hydrates, metal sulfides, metal sulfates, metal chromates and metal molybdates, as well as organic color pigments and/or dyes such as carbonyl colorants, cyanine colorants and others may be used to color the base papers.

In a preferred embodiment, the base paper to be printed herein is at least one paper web without impregnation having at least one ink-receiving layer. The ink-receiving layer is preferably a hydrophilic coating comprising water-soluble or water-dispersible polymers or binders and inorganic pigments.

For example, polyvinyl alcohol, polyvinyl pyrrolidone, polyvinyl acetate, starch, gelatin, carboxymethyl cellulose, ethylene/vinyl acetate, styrene/acrylic acid ester copolymers or mixtures thereof may be used as binders.

Inorganic white pigments such as silicates, kaolin, calcium carbonate, aluminum hydroxide, talc, titanium dioxide, or color pigments such as iron oxide, carbon black, or organic color pigments may be present as inorganic pigments in the ink-receiving layer. The ratio of pigment to binder in the ink-receiving layer is between 1:0.05-1:1 based on the solids content.

In a preferred embodiment, the ink-receiving layer contains silicates, aluminum oxides, aluminum hydroxides, or aluminum silicates and polyvinyl alcohol as a water-soluble polymeric binder.

The basis weight of the ink-receptive layer can be between 0.5-20 g/m².

In a further embodiment, the at least one carrier material to be printed is at least one pre-treated impregnated paper. In this context, a pre-treated paper (or cellulose layer) is understood to be a paper or paper web impregnated with a resin solution. The paper may be impregnated with a wide variety of resin solutions, for example melamine resins and urea resins, plastic-acrylate compounds or starch-glue. It is also possible to impregnate the paper using resin powder. The use of resin powder is described in detail below.

In a preferred embodiment, an impregnated paper is used, which is provided by the following process steps (see also EP 2 980 313 A1): a) complete impregnation of the cellulose layer with a curable resin, e.g. melamine-formaldehyde resin), b) removing the excess resin forming on the surface (e.g. by peeling or scraping off), c) drying the impregnated cellulose layer in such a way that, after evaporation of the water from the resin, the cellulose fibres on the surface from which the resin has been removed are at least partially exposed.

Peeling or doctoring causes the resin remaining on the surface of the cellulose layer to seal with the fiber tips. In the drying process, the resin retracts into the fibers so that the fibers are impregnated with the resin but not enclosed by the resin. Such a surface is suitable for printing with aqueous digital printing inks.

The special equipment used for doctoring works similar to a spatula machine where one or more rollers run backwards on the paper and pick up the excess resin. By varying the speed of the rollers, the amount can be precisely controlled and repeatability ensured.

To improve the printing result, the treated paper (base paper without or with ink-receptive layer, impregnated paper) can additionally be provided with a primer material.

The primer material may be a water-based synthetic resin or acrylic resin dispersion that is completely miscible with water or partially soluble in water. The primer material should have a low solvent content of less than 3%.

As indicated above, the printed decoration is applied to the carrier material in direct printing by means of a digital printing process using the CRYK ink described above. In digital printing, the printed image is transferred directly from a computer to a printing machine, such as an inkjet printer. The decor data is translated into machine data by software (e.g. RIP software from the manufacturer Colorgate).

The printed papers (base paper or impregnated paper) may be provided with a resin layer as a protective layer after printing. This protective layer may comprise a resin which has not yet fully cured, preferably a formaldehyde-containing resin, in particular preferably melamine-formaldehyde resin, urea-formaldehyde resin and/or melamine-urea-formaldehyde resin, or a radiation-curable acrylate, preferably polyester acrylates, polyether acrylates, urethane acrylate, hexanediol diacrylate or mixtures thereof. This protective layer serves to protect the printing decorations and enables intermediate storage.

As mentioned, the applied protective layer should not yet be fully cured, which is controlled in particular by the drying process.

In particular, all impregnated papers must have a residual moisture content, regardless of the intended use. This enables the creation of qualitatively flawless products, regardless of the type of further processing (short-cycle, Conti or multi-daylight press). The residual moisture is an indication of the degree of cross-linking of the synthetic resins used.

The resins used for impregnation of paper layers (or also for direct coating of other carrier plates, see below) pass through various polymerisation and cross-linking states in these processes.

This is illustrated below using the example of melamine-formaldehyde resin, which is frequently used in the manufacture of wood-based panels.

Melamine and formaldehyde first react to form methylol groups on the amino groups of melamine to form water-soluble products (see Scheme I).

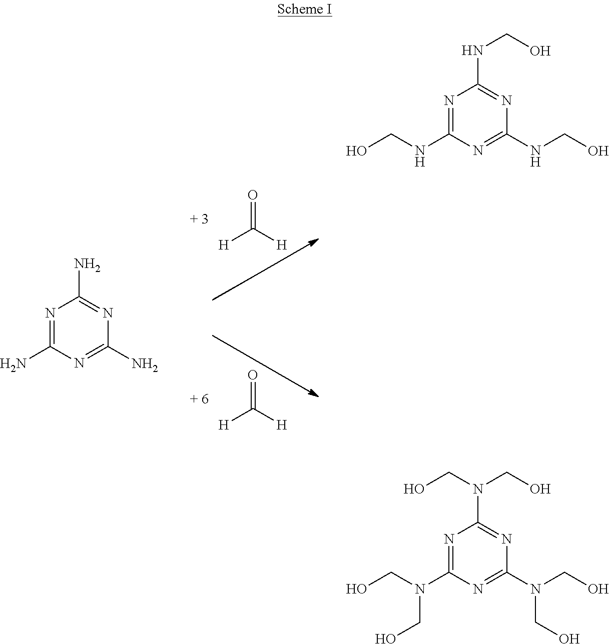 [SMILES: OCNc1nc(NCO)nc(NCO)n1 ; C=O ; Nc1nc(N)nc(N)n1 ; C=O ; OCN(CO)c1nc(N(CO)CO)nc(N(CO)CO)n1]

These melamine-formaldehyde monomers undergo polycondensation after the addition of a suitable catalyst, preferably an acid, resulting in the linkage of the monomers via ether and methylene groups and the formation of higher molecular weight precondensates and polycondensates (see Scheme II).

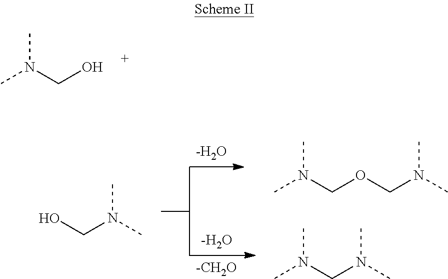

Precondensates and polycondensates differ with regard to their molar mass and solubility. Thus, the low molecular weight precondensates may still have limited water solubility, while the higher molecular weight polycondensates are insoluble. The limited water solubility of the precondensates is caused, among other things, by still free methylol groups and the low degree of cross-linking of the mostly still linear oligomers. The precondensates are thus a polymerization intermediate.

Complete curing of the polycondensates leads to strong crosslinking with cleavage of the methylol groups still present, whereby closely crosslinked plastics are formed via methylene groups (see Scheme III).

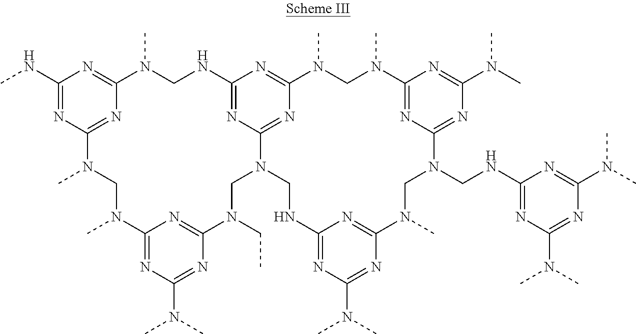

For synthetic resins curing via condensation reactions, a distinction is therefore made between the following resin states:
A-state: easily soluble in solvents, meltable, hardenable;
B-state: only partially soluble in solvent, meltable, hardenable;
C-State: insoluble, cured

In the case of using impregnated paper layers for finishing wood-based panels, e.g. for high-quality flooring panels, it is desirable that the impregnating resin is not yet fully cured, but is preferably still in the partially crosslinked B-state. During further processing in the press, this still permits flowing/filming in combination with further crosslinking of the synthetic resins. Accordingly, the present impregnated and printed papers are preferably dried to the B state.

The printed and, if necessary, coated or impregnated paper can then be pressed with a material plate, at least one protective paper (overlay) and, if necessary, a backing paper.

In a further embodiment, the at least one carrier material to be printed is at least one material board, in particular a wood material board, such as MDF and HDF boards made of wood fibers, particle boards made of chips, OSB made of wood strands, wherein the wood fibers, wood chips and wood strands are each mixed with suitable adhesives and hot-pressed), WPC boards, plastic board, for example SPC (stone plastic composite) or a cement fiber board. Suitable for direct printing are, for example, carrier materials such as wood materials, wood material-plastic mixtures, WPC, plastics or mixtures of different plastics, for example PE, PP, PVC, PU, all also with fillers, such as chalk, talc or also fibres.

In one embodiment, the surface of the material plate may be pre-treated prior to printing to improve the adhesion of the subsequent layers. This can be a cleaning with brushes, a grinding, which also frees the surface from irregularities, and/or a plasma or corona treatment.

In one embodiment, an unsanded wood-based panel, in particular MDF or HDF, can also be used, which is still provided with a pressed skin (rotting layer) on the upper side. Aqueous melamine resin is applied to the upper side to fill the pressed skin. The melamine resin is later melted in the short-cycle press and thus has a tempering effect in the area of this layer; i.e. it counteracts delamination.

In a preferred embodiment, the next step is to apply at least one base coat to increase opacity.

The base coat preferably comprises casein, corn starch or soy protein and may contain inorganic color pigments and thus serve as a primer layer for the decorative layer to be subsequently printed.

White pigments such as titanium dioxide TiO₂ can again be used as colour pigments. Further colour pigments can be calcium carbonate, barium sulphate or barium carbonate, but also iron oxide pigments (for a brownish primer). In addition to the color pigments and the casein, corn starch or soy protein, the primer may also contain water as a solvent.

The amount of liquid base coat applied may be between 10 and 50 g/m², preferably between 15 and 30 g/m², more preferably between 20 and 25 g/m².

It is also conceivable that the base coat comprises at least one, preferably at least two or more successively applied layers or applications (e.g. up to five applications), wherein the application amount between the layers or applications is the same or different, i.e. the application amount of each individual layer may vary.

The base coat can be applied to the material support plate using a roller with subsequent drying. It is also possible to apply the base coat to the material plate using digital printing. In this case, water-based inks enriched with white color pigments are preferably used, which are suitable for the digital printing inks used below. An application by means of digital printing is advantageous, since the printing equipment is significantly shorter than a rolling device and thus saves space, energy and costs.

In a further embodiment of the present method, a primer layer is applied to the base coat, preferably as a single application with subsequent drying. The amount of liquid primer applied is between 10 and 30 g/m², preferably between 15 and 20 g/m². Polyurethane-based compounds are preferably used as primers.

Following the printing of the primed material plate in digital printing using the CRYK ink described above, the decorative layer can also be provided with a protective coating (as already described above for the papers).

This protective layer may be a formaldehyde-containing resin (in the B state, see above), in particular a melamine-formaldehyde resin, urea-formaldehyde resin or melamine-urea-formaldehyde resin, and may contain glass spheres (size 50-150 μm) as spacers for optional intermediate storage of the boards. This protective layer provides temporary protection of the decorative layer for storage prior to further finishing. The protective layer on the decorative layer is not yet fully cured, but has a certain residual moisture of about 10%, preferably about 6%, and can still be further crosslinked. In the case of intermediate storage, the resin thus remains in state B (not yet fully cured and cross-linked), with the decor being protected. The glass beads can be added to the resin or sprinkled on top and act as spacers. Such protective layers are described, for example, in WO 2010/112125 A1 or EP 2 774 770 B1.

Alternatively, you can go directly to the next processing step.

In a more advanced embodiment, at least one wear protection layer is applied to the printed material board (with or without a protective layer).

This wear protection layer can consist of one or more layers, e.g. three, four, five or six layers.

In one embodiment, a wear protection layer is applied using the following steps:
applying at least one first resin layer to the at least one decorative layer on the upper surface of the material board, the first resin layer having a solids content of between 60 and 80% by weight, preferably between 65 and 70% by weight, more preferably between 65 and 67% by weight;
uniform scattering of abrasion-resistant particles on the first resin layer on the upper side of the material board;
wherein the first resin layer provided with the abrasion-resistant particles on the upper surface of the material board is optionally not dried after the application,
applying at least one second resin layer to the first, optionally moist, resin layer provided with the abrasion-resistant particles on the upper side of the material board, the second resin layer having a solids content of between 60 and 80% by weight, preferably between 65 and 70% by weight, in particular preferably between 65 and 67% by weight;
subsequent drying of the assembly of the first resin layer and the second resin layer in at least one drying apparatus;
applying at least one third resin layer, the third resin layer having a solids content of between 60 and 80% by weight, preferably between 65 and 70% by weight, more preferably between 65 and 67% by weight, and containing glass beads;
subsequent drying of the applied third resin layer in at least one further drying apparatus;
applying at least one fourth resin layer, the fourth resin layer having a solids content of between 50 and 70% by weight, preferably 55 and 65% by weight, more preferably between 58 and 62% by weight, and comprising glass beads;
subsequent drying of the applied fourth resin layer in at least one further drying apparatus;
applying at least a fifth resin layer, the fifth resin layer having a solids content of between 50 and 70% by weight, preferably 55 and 65% by weight, more preferably between 58 and 62% by weight, and comprising glass beads;
subsequent drying of the applied fifth resin layer in at least one further drying apparatus;
applying at least a sixth resin layer, the sixth resin layer having a solids content of between 50 and 70% by weight, preferably 55 and 65% by weight, more preferably between 58 and 62% by weight, and containing no glass beads;
subsequently drying the applied sixth resin layer in at least one further drying apparatus; and
Pressing of the layer structure in a short-cycle press.

The resin layers used for the wear protection layer are preferably based on aqueous formaldehyde-containing resins, in particular melamine-formaldehyde resin, urea-formaldehyde resin or melamine-urea-formaldehyde resin.

The resins used preferably each contain additives, such as hardeners, wetting agents (surfactants or mixtures thereof), defoamers, release agents and/or other components. The wetting agent is used in the resin layers each in an amount of 0.1-1 wt %. Release agents and smoothing agents are preferably added to the fifth and sixth resin layers in amounts between 0.5-1.5 wt %.

The preferred hardener is a latent hardener, such as alkanolamine salts of acids, e.g. an alkanolamine salt of a sulfonic acid (see DeuroCure from the manufacturer Deurowood). Preferably, the latent hardener is added to the resin immediately before the applicator to avoid premature curing of the resin and thus losses. Accordingly, there is preferably no central admixing of the hardener, but rather admixing of the variable amount of hardener only at the corresponding application units. This has the advantage that, in the event of a malfunction of the system, the resin can remain in the lines longer without the hardener. Only the application units with resin hardener have to be specifically adjusted to the pot life of the system. This significantly reduces losses due to the need to pump out the resin hardener in the event of a shutdown or malfunction.

The proportion of hardener in the individual resin layers varies and can be between 0.5 to 1.5 wt %, preferably 0.7 to 1.3 wt %. It is particularly preferred that the amount of hardener per resin layer decreases in the direction of production; that is, the amount of hardener is greater in the lower resin layers than in the upper resin layers. By reducing the amount of hardener from the lower to the upper resin layers, uniform curing of the individual resin layers in the KT press can be realized.

In one variant of the method, the first resin layer is applied in an amount between 10-100 g/m^{2,} preferably 40-80 g/m², more preferably 45-60 g/m². The first resin layer is applied, for example, with a grooved applicator roller in a first applicator unit.

The first resin layer may include cellulose fibers or wood fibers, preferably cellulose fibers. By adding cellulose fibers, the viscosity of the resin to be applied can be adjusted and the application of the first top layer to the wood-based panel can be increased. The amount of cellulose fibers applied with the first resin layer may be between 0.1 and 1 wt %, preferably between 0.5 and 0.8 wt % (based on the amount of resin to be applied) or between 0.1-0.5 g/m², preferably 0.2-0.4 g/m², more preferably 0.25 g/m². The cellulose fibers preferably used have a white color and are in the form of a fine or granular, slightly hygroscopic powder.

In another embodiment of the present method, abrasion resistant particles, particles of corundum (aluminum oxides), boron carbides, silicon dioxides, silicon carbides are used. Particles of corundum are particularly preferred. Preferably, these are noble corundum (white) with a high transparency, so that the optical effect of the underlying decoration is adversely affected as little as possible. Corundum has an irregular spatial shape.

The amount of scattered abrasion-resistant particles is 10 to 50 g/m², preferably 10 to 30 g/m², more preferably 15 to 25 g/m². The amount of scattered abrasion-resistant particles depends on the abrasion class to be achieved and the particle size. Thus, in the case of abrasion class AC3, the amount of abrasion-resistant particles is in the range between 10 to 15 g/m², in abrasion class AC4 between 15 to 20 g/m² and in abrasion class AC5 between 20 to 25 g/m² when using grain size F200. In the present case, the finished boards preferably have abrasion class AC4.

Abrasion-resistant particles with grain sizes in classes F180 to F240, preferably F200, are used. The grain size of class F180 covers a range of 53-90 μm, F220 from 45-75 μm, F230 34-82 μm, F240 28-70 μm (FEPA standard). In one embodiment, the abrasion resistant particles used are noble corundum white F180 to F240, preferably in a main grain size range of 53-90 μm. In a particularly preferred embodiment, corundum particles of class F200 are used, where F200 is a mixture between F180 and F220 and has a diameter between 53 and 75 μm.

The abrasion-resistant particles must not be too fine-grained (risk of dust formation), but also not too coarse-grained. The size of the abrasion-resistant particles is thus a compromise.

In a more advanced embodiment, silanized corundum particles may be used. Typical silanizing agents are aminosilanes.

In another embodiment of the present method, the second resin layer to be applied to the upper surface of the material board is applied in an amount between 10-50 g/m², preferably 20-30 g/m², more preferably 20-25 g/m². Overall, the amount of the second resin layer is less than the amount of the first resin layer. In a preferred embodiment, the second resin layer to be applied to the upper surface of the material board does not contain glass beads.

The total amount of first and second resin layer is between 50-100 g/m², preferably 60-80 g/m², more preferably 70 g/m². Thus, in one variant, the amount of the first resin layer is 50 g/m² and the amount of the second resin layer is 25 g/m².

An accumulation of abrasion-resistant particles occurs in the second resin layer due to entrainment of loose particles by the second applicator. Thus, a content of abrasion-resistant particles of 5 to 15 wt %, preferably 10 wt %, may be obtained in the resin to be applied as the second resin layer.

As explained above, further resin layers, a third, a fourth, a fifth and a sixth resin layer, are subsequently applied on top of the second resin layer and are each dried after application.

The amount of the third resin layer applied to the upper surface of the wood-based panel may be between 10-50 g/m², preferably 20-30 g/m², more preferably 25 g/m².

As explained above, the third resin layer contains glass beads that act as spacers. The glass beads preferably used have a diameter of 90-150 μm. The glass beads may be applied together with the third resin layer or separately sprinkled on the third resin layer. The amount of glass beads is 10 to 50 g/m², preferably 10 to 30 g/m², more preferably 15 to 25 g/m². The batch preferably comprises about 40 kg of resin liquid plus glass beads and auxiliary materials. The glass beads may also be in silanized form. Silanization of the glass beads improves the embedding of the glass beads in the resin matrix.

The amount of the fourth resin layer (which also contains glass beads) applied to the upper surface of the wood-based panel may be between 10-40 g/m², preferably 15-30 g/m², more preferably 20 g/m².

As explained above, the solids content of the fourth resin layer (as well as the fifth and sixth resin layers) is lower compared to the first to third resin layers. On the one hand, the varying solid content of the resin layers to be applied enables a higher overall layer thickness due to the increased solid content in the first to third layers, and on the other hand, the reduced solid content in the fourth to sixth resin layers ensures that the drying and pressing time is sufficient for the overall structure.

The amount of the fifth resin layer applied to the upper surface of the wood-based panel may be between 10-40 g/m², preferably 15-30 g/m². As stated above, the fifth resin layer also includes glass beads. The glass beads may be applied together with the third resin layer or sprinkled separately on the third resin layer. The glass beads are applied in an amount of 8 to 10 kg per application.

On the other hand, the sixth resin layer to be applied to the fifth resin layer after drying does not contain glass beads. The omission of glass beads in the sixth resin layer ensures that the underlying resin layers, which have already dried, are not destroyed and the surface of the resin structure does not appear torn.

The total layer thickness of the applied resin layers on the wood-based panel can be between 60 and 200 μm, preferably between 90 and 150 μm, more preferably between 100 and 120 μm. The total layer thickness is thus significantly higher than previous methods, which typically achieve layer thicknesses of up to 50 μm.

In another embodiment, one resin layer is applied to each of the bottom surface of the material board along with the second, third, fourth, fifth, and sixth resin layers to be applied to the top surface of the material board.

Thus, in one embodiment, a resin layer is also applied to the underside of the material board in parallel with the second resin layer on the upper side of the material board. The amount of resin layer applied to the bottom surface of the material board may be between 50-100 g/m², preferably 60-80 g/m², more preferably 60 g/m². Preferably, the bottom resin layer is coloured (e.g. brownish) to simulate a counter-draught. Preferably, the second resin layer is applied in parallel or simultaneously to the upper side and lower side of the material board in at least one double application device (roller application unit). After application of the second resin layer, drying (air drying) of the assembly of first and second resin layers takes place in a first drying device.

In the same way, a third, a fourth, a fifth and a sixth resin layer are applied to the lower side parallel to the upper side in double application units on the carrier board, and are each dried following the application.

The resin layer(s) applied to the underside act as a counter-tension. Applying the resin layers to the top and bottom of the material board in approximately equal amounts ensures that the tensile forces on the material board caused by the applied layers cancel each other out during pressing. The countercoat applied to the underside corresponds in its layer structure and the respective layer thickness approximately to the layer sequence applied to the upper side, but without the addition of glass beads.

The resin layers are dried at dryer temperatures between 150 and 220° C., preferably between 180 and 210° C., in particular in a convection dryer. The temperature is adapted to the respective resin layers and may vary in the individual convection dryers; for example, the temperature in the second, third and fourth convection dryers may be 205° C. and in the fifth and sixth convection dryers each 198° C. However, other dryers may be used instead of convection dryers.

In the pressing step following the last drying step, the layer structure is pressed under the influence of pressure and temperature in a short-cycle press at temperatures between 150 and 250° C., preferably between 180 and 230° C., more preferably at 200° C., and at a pressure between 30 and 60 kg/cm², more preferably between 40 and 50 kg/cm². The pressing time is between 5 to 15 sec, preferably between 7 to 10 sec. In comparison: for decorative papers, a pressure of 50-60 kg/cm² is applied for 16 sec.

Preferably, the coated material board is aligned in the short-cycle press with respect to a textured press plate located in the short-cycle press by means of markings on the wood-based material plate, so that congruence is produced between the decor on the wood-based material plate and the structure of the press plate to be imprinted. This enables the production of a decor-synchronous structure. During pressing, the melamine resin layers melt and a laminate is formed by a condensation reaction involving the corundum/glass/fibre components.

In another embodiment, the material board is processed using the following process steps:
a) applying at least one first layer of at least one powdered resin to at least one side of a wood-based panel and fusing the at least one applied layer of powdered resin;
a1) optional application of at least one base coat which may contain colour pigments, in particular white colour pigments;
a2) optional application of at least one primer layer;
b) applying at least one printed decoration or decorative layer by digital printing using the CRYK ink described above; and
c) applying at least one further (second) layer of at least one powdered resin to the at least one imprinted decorative layer and melting-on the at least one layer of powdered resin spread on the decorative layer.

In one embodiment of the present method, the powdered resin is applied to the wood-based panel in an amount of 10 to 50 g/m², preferably 15 to 30 g/m², more preferably 20 to 25 g/m². This application amount of powdered resin applies essentially to all the layers of powdered resin to be applied, although these can be adjusted in each case. The spreading density is selected in such a way that covering layers are produced in each case.

The particle size of the powdered resin is between 20 to 100 μm, preferably between 40 and 89 μm.

In another embodiment of the present method, the powdered resin to be applied is a formaldehyde resin, preferably a urea resin, a melamine resin or a phenolic resin, more preferably a melamine-formaldehyde resin. It is preferred if a melamine resin or a urea resin is used for the first resin layer. Preferably, only melamine resin is used in the upper layers.

“Melting-on” or “gelation” in the sense of the present application means that the resin layer is not yet completely polymerized, but rather the polymerization is stopped at an intermediate stage in which further crosslinking or polymerization is still possible at a later processing time. The purpose of “gelling” is thus usually to apply further functional layers to the already applied protective layer at a later time or to finish the product in further processing steps.

Other substances can also be added to the melamine resin powder. It is particularly advantageous that substances which are poorly compatible with liquid melamine resin, e.g. because of salting-out, thickening, settling, curing effects, etc., can also be used. These may be salts to increase conductivity, organic or inorganic flame retardants, cellulose derivatives, radical scavengers, pigments, UV absorbers, etc.

Accordingly, the powdered resin used may contain additives such as pigments, conductive substances and cellulose.

If color pigments are added, the layer of melted resin powder can simultaneously serve as a white base coat for the decorative layer to be subsequently printed on. White pigments such as titanium dioxide TiO₂ can be used as color pigments. Other color pigments may be calcium carbonate, barium sulfate or barium carbonate. The proportion of color pigments may be up to 50% by weight of the total amount of powder.

The addition of colour pigments to the first layer of resin powder increases the opacity, so that this can be used as a (sole) base or primer for the subsequent decorative layer.

In a preferred embodiment, the resin powder is applied by electrostatic charging. The application can also be carried out by means of powder coating according to the tribo method. In this case, the powder to be applied is frictionally charged.

The melting-on of the applied layer of powdered resin can be done using an IR radiator, or microwave systems or the like. The use of IR emitters is particularly preferred.

The further powder resin layer applied and fused on in step c) of the present method preferably comprises formaldehyde resin-based powder, particularly preferably melamine-formaldehyde resin. The amount of resin powder applied in this step is between 10 and 50 g/m², preferably between 20 and 40 g/m².

In a more advanced embodiment, abrasion resistant particles are uniformly sprinkled on the decorative layer or the resin powder layer applied in step c) (step d).

In a more advanced embodiment of the present method, at least a third layer of at least one powdered resin (step e) is applied, in particular to the layer of abrasion-resistant particles. This layer serves as a separation layer for blocking the abrasion-resistant particles.

The powder resin layer applied and melted-on in this step e) preferably comprises formaldehyde resin-based powder, particularly preferably melamine-formaldehyde resin. The amount of resin powder applied in this step is between 10 and 50 g/m², preferably between 20 and 40 g/m².

In a further embodiment of the present method, glass beads are sprinkled, in particular on the at least one third molten-on resin powder layer (step f). The glass beads serve as spacers between abrasion-resistant particles and subsequent pressed sheet metal. Thus, the sheet wear can be at least partially reduced.

In a further embodiment of the present method, at least a fourth layer of at least one powdered resin is applied, in particular to the layer of glass spheres (step g). This layer serves to seal off the glass spheres and as a finishing layer.

The fourth powder resin layer applied and melted-on in this step g) preferably comprises formaldehyde resin-based powder, particularly preferably melamine-formaldehyde resin. The application amount of resin powder in this step is between 10 and 50 g/m², preferably between 20 and 40 g/m².

In a further embodiment of the present method, the layered structure is pressed in a short-cycle press (KT press) (step h). The pressing step is carried out under the influence of pressure and temperature at temperatures between 180 and 250° C., preferably between 200 and 230° C., more preferably at 200° C. and at a pressure between 30 and 60 kg/cm ², more preferably between 40 and 50 kg/cm ². The pressing time is between 8 and 30 sec, preferably between 10 and 25 sec.

The solution will be explained in more detail below with reference to examples of embodiments.

### DESCRIPTION OF THE INVENTION

### Example 1a: Printing on Base Paper

A raw paper (paper weight: 80 g/m²) is unrolled from an unwinding device.

Application of a decorative layer by digital printing using a CRYK ink with the following composition: PB15:3 2.0 wt %, PR207 2.0 wt %, PY181 2.0 wt %, PBL7 2.0 wt %; glycol 41%, water 51%; density 1.07 g/cm³; VOC 29%, 305 g/l; flash point >100° C.

The printing inks are applied in a quantity between 5 and 10 g/m².

After printing, the printed paper can be provided with a melamine-formaldehyde resin layer as a protective layer. This protective layer serves to protect the printed decorations and enables intermediate storage.

The paper is then dried in a convection dryer or by NIR (near infrared) to a moisture content of about 6 wt % so that the resin layer is in the B state.

### Example 1b: Printing on Base Paper With Ink-Receiving Layer

A base paper (paper weight: 80 g/m²) is unrolled from an unwinding device. A pigmented (TiO₂) ink receptive layer (synthetic silicate with polyvinyl alcohol as binder) (layer thickness 40 μm; after drying at 125° C. dry basis weight 4 g/m²) and a primer layer are then applied and the layer structure is dried.

After drying, a decorative layer is applied to the paper thus obtained (paper weight: 80 g/m²) by digital printing using a CRYK ink with the above composition. The inks are applied in an amount between 5 and 10 g/m².

After printing, the printed paper can be provided with a melamine-formaldehyde resin layer as a protective layer. This protective layer serves to protect the printed decorations and enables intermediate storage.

The paper is then dried in a convection dryer or by NIR (near infrared) to a moisture content of about 6 wt % so that the resin layer is in the B state.

### Example 2a: Printing of a First Impregnate With Ink-Receiving Layer

The paper to be printed is impregnated on the front and back with a liquid melamine resin in an impregnation device. In the process, approx. 50 g melamine resin/m² with a solids content of approx. 50% is applied.

Subsequently, a pigmented (TiO₂) ink receptive layer (synthetic silicate with polyvinyl alcohol as binder) (layer thickness 40 μm; after drying at 125° C. dry basis weight 4 g/m²) and a primer layer are applied and the layer structure is dried.

After drying, a decorative layer is applied to the resulting impregnate (paper weight: 80 g/m²) by digital printing using a CRYK ink with the above composition. The inks are ²applied in an amount between 5 and 10 g/m.

After printing, the printed paper can be coated with a melamine-formaldehyde resin layer as a protective layer.

The paper is then dried in a convection dryer or by NIR (near infrared) to a moisture content of about 6 wt % so that the resin layer is in the B state.

### Example 2b: Printing of a Second Impregnate With Ink-Receiving Layer

The paper to be printed is coated in an application device with melamine resin powder in a quantity of 25 g/m² using tribo guns. The melamine resin powder contained the usual auxiliary materials such as hardener, release agent, etc. Then the powder is melted by infrared radiation.

Subsequently, a pigmented (TiO₂) ink receptive layer (synthetic silicate with polyvinyl alcohol as binder) (layer thickness 40 μm; after drying at 125° C. dry basis weight 4 g/m²) and a primer layer are applied and the layer structure is dried.

After drying, a decorative layer is applied to the resulting impregnate (paper weight: 80 g/m²) by digital printing using a CRYK ink with the above composition. The inks are applied in an amount between 5 and 10 g/m².

After printing, the printed paper can be coated with a melamine-formaldehyde resin layer as a protective layer.

The paper is then dried in a convection dryer or by NIR (near infrared) to a moisture content of about 6 wt % so that the resin layer is in the B state.

### Example 2c: Printing of a Third Impregnate

The paper to be printed is impregnated on the front and back with a melamine resin in an impregnation device. In the process, approx. 50 g melamine resin/m² with a solids content of approx. 50% is applied.

Before the dryer, the resin on the side of the impregnate to be printed is removed with a special device (e.g. a knife doctor blade) so that fibres remain free to take up the printer's ink.

After drying, a decorative layer is applied to the resulting impregnate (paper weight: 80 g/m²) by digital printing using a CRYK ink with the above composition. The inks are applied in an amount between 5 and 10 g/m².

Further drying of the printed impregnate is not necessary, as the digital printing ink only introduces a small amount of moisture.

### Example 3: Printing a Plate With Liquid Overlay

An HDF board (fibreboard with increased bulk density) is first pre-coated with an aqueous synthetic resin (melamine-formaldehyde resin). The application quantity is 20-50 g resin liquid/m² (solids content: approx. 55%). The resin contains the usual additives such as wetting agents, hardeners, release agents and defoamers. The applied resin is then dried in a convection dryer or a near-infrared oven to a moisture content of approx. 20%. Then several coats of a water-based pigmented base coat are applied (5-8×). After each application, the base coat is dried using a convection dryer or a near-infrared dryer.

In the following, the base coated plate is printed with a motif using a digital printer. Approx. 6-8 g/m² of the water-based CRYK digital printing ink is used.

After drying of the decorative layer, approx. 70 g of melamine resin fl. (solids content: 55% by weight) containing the usual additives (hardener, wetting agent, etc.) is applied to the printed board surface. A melamine resin is also applied to the underside of the board with the first roller application unit (application quantity: 60 g resin fl./m², solids content: approx. 55% by weight).

Afterwards 14 g corundum/m² (F 200) are sprinkled on the surface with a sprinkling apparatus. A distance of approx. 5 m to the dryer allows the corundum to sink into the melamine resin. Then the board passes through a circulating air dryer. Then a melamine resin layer (solids content: 55% by weight) is applied in a quantity of 25 g/m². This also contains the usual additives. A melamine resin is also applied to the underside of the board using a roller application unit (application quantity: 50 g resin fl./m², solids content: approx. 55% by weight). Again, the board is dried in a circulating air dryer.

Then a melamine resin is applied to the surface of the board, which also contains glass beads. These have a diameter of 60-80 μm. The application quantity of the resin is approx. 20 g melamine resin fl./m² (solids content: 61.5 wt %). In addition to the hardener and the wetting agent, the formulation also contains a release agent. The application quantity of glass beads is approx. 3 g/m². A melamine resin is also applied to the underside of the board using a roller application unit (application quantity: 40 g resin fl./m², solids content: approx. 55 wt %). The board is again dried in a circulating air dryer and then coated again with a melamine resin containing glass beads. Cellulose (Vivapur 302) is included as a further component. Again approx. 20 g melamine resin fl./m² (solids content: 61.6 wt %) are applied. Again approx. 3 g glass beads and 0.25 g cellulose/m² are applied. In addition to the hardener and the wetting agent, the formulations also contain a release agent. A melamine resin is also applied to the underside of the board using a roller application unit (application quantity: 30 g resin fl./m², solids content: approx. 55% by weight). The resin is again dried in a circulating air dryer and then the board is pressed in a short cycle press at 200° C. and a pressure of 400 N/cm². The pressing time was 10 seconds. A press plate with a wooden structure was used as the structure generator.

### Example 4: Printing a Plate With Powder Overlay

In a production line, 8 mm HDF is separated, cleaned of dust with the help of brushes and then transported further via roller conveyors.

In an application device, they are then coated with melamine resin powder in an amount of 25 g/m² using tribo guns. The melamine resin powder contained the usual auxiliary materials such as hardener, release agent, etc. The powder is then melted-on by infrared radiation.

The base coated panel is then coated with a colour base coat multiple coats with subsequent intermediate drying (circulating air). The colour is a mixture of casein and pigment (titanium dioxide). The application quantity per application is approx. 5 g fl./m². The application is repeated at least five times. This is followed by the application of a primer (application quantity: 10-20 g fl./m²) with circulating air drying.

The plate is then printed with a digital printer using the aqueous CRYK ink. The application quantities of ink are 3 to 15 g fl./m². The ink is dried via IR radiation or circulating air.

Corundum is sprinkled onto the print with a sprinkling device (application quantity: 20 g corundum/m², F 180).

Afterwards, melamine resin powder is again applied with a tribo gun (application quantity: 80 g/m²). This melamine resin powder is again gelled with the aid of an IR radiator. The melamine resin powder contained the usual auxiliary materials such as hardeners, release agents, etc.

Then the board is pressed in a KT press together with a counter-impregnate. The pressing conditions were: T=200° C., p=40 kg/cm² and t=25 sec. The pressed board was then visually inspected and no abnormalities were found. The surface tests subsequently carried out in accordance with DIN EN 15468-August 2018 also showed no abnormalities. All requirements of stress class 32 were met.

1. A method for the production of at least one carrier material provided with a print decoration, wherein the print decoration is applied to the at least one carrier material by means of digital printing,
wherein the ink used for digital printing is a water-soluble CRYK ink containing at least one cyan pigment, at least one red pigment from the group of quinacridone pigments, the yellow pigment PY181 and at least one black carbon pigment.

2. The method according to claim 1, wherein the at least one cyan pigment is a copper phthalocyanine pigment, preferably C.I. Pigment Blue 15:3 or C.I. Pigment Blue 15:4, more preferably C.I. Pigment Blue 15:3.

3. The method according to claim 1, wherein the at least one red pigment is selected from the group of quinacridone pigments containing 2,9-dimethylquinacridone (pigment red 122), 2,9-dichloroquinacridone (pigment red 202), mixed crystal of quinacridone and 4,11-dichloroquinacridone (pigment red 207) and 3,10-dichloroquinacridone (pigment red 209), wherein pigment Red 207 is in particular preferred.

4. The method according to claim 1, wherein the black carbon pigment is a carbon black pigment, in particular selected from the group consisting of Regal™ 400R, Mogul™, L, Elftex™ 320 from Cabot Co, or Carbon Black FW18, Special Black™ 250, Special Black™ 350, Special Black™ 550, Printex™ 25, Printex™ 35, Printex™ 55, Printex™ 90, Printex™ 150T from DEGUSSA Co, MA8 from MITSUBISHI CHEMICAL Co, and C.I. Pigment Black 7 and C.I. Pigment Black 11.

5. The method according to claim 1, wherein the pigment concentration is more than 2% by weight, preferably between 2.2 and 6% by weight, more preferably between 2.5 and 5% by weight, based on the total weight of the ink.

6. The method according to claim 1, wherein the water content in the ink is at least 50%, preferably at least 55%.

7. The method according to claim 1, wherein the ink contains at least one organic solvent in a proportion of less than 45%, preferably less than 43%.

8. The method according to claim 1, wherein the at least one carrier material to be printed is a base paper.

9. The method according to claim 8, wherein the at least one base paper is at least one paper web without impregnation with at least one ink-receiving layer containing white pigments.

10. The method according to claim 1, wherein the at least one carrier material to be printed is pre-treated, impregnated paper.

11. The method according to claim 10, wherein the at least one impregnated paper is an impregnated paper web having at least one primer layer and at least one ink receiving layer containing white pigments.

12. The method according to claim 8, wherein the paper is impregnated with at least one resin after printing.

13. The method according to claim 8, wherein the printed and impregnated paper is pressed with a material board, at least one protective paper and optionally a backing paper.

14. The method according to claim 1, wherein the at least one carrier materials is at least one material board, in particular a wood material board, such as MDF board, HDF board, OSB board, chipboard or WPC, plastic board such as SPC (stone plastic composite), cement fibre board, which has at least one primer containing white pigments.

15. The method according to claim 14, wherein the printed wood-based panel is provided with at least one wear protection layer.
